(19) United States
(12) Patent Application Publication
(10) Pub. No.: US 2018/0090776 A1
(43) Pub. Date: Mar. 29, 2018

(54) Polymer Electrolyte Fuel Cell-Based Power System for Long-Term Operation of Leave-In-Place Sensors

(71) Applicant: The United States of America as represented by the Secretary of the Navy, San Diego, CA (US)

(72) Inventors: Andrew M. Higier, San Diego, CA (US); Jonathon K. Oiler, San Diego, CA (US); Alex Phipps, San Diego, CA (US); Ralph D. Cooper, Lemon Grove, CA (US); Lewis Hsu, San Diego, CA (US)

(21) Appl. No.: 15/274,268

(22) Filed: Sep. 23, 2016

(51) Int. Cl. H01M 8/065; H01M 16/00; H01M 8/04746; H01M 8/0444; H01M 8/04537

(52) U.S. Cl. CPC H01M 8/065; H01M 16/006; H01M 8/04753; H01M 2008/1095; H01M 8/04552; H01M 8/04626; H01M 8/04447

(57) ABSTRACT

A method for power delivery comprising the steps of coupling a polymer electrolyte membrane fuel cell (PEM-FC) to a load system, wherein the PEM-FC is powered by hydrogen gas and oxygen; using a blower to deliver oxygen to the PEM-FC; using an automated electro-chemical control system to monitor PEM-FC hydrogen gas levels, PEM-FC voltage, and load demands; determining that more hydrogen gas is required to fuel the PEM-FC, mixing sodium borohydride, a catalyst, and water, releasing hydrogen gas and delivering the hydrogen gas to the PEM-FC, and transferring the resulting power from the PEM-FC to the load system.

### FEDERALLY-SPONSORED RESEARCH AND DEVELOPMENT

Polymer Electrolyte Fuel Cell-Based Power System for Long-Term Operation of Leave-In-Place Sensors is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email ssc_pac_T2@navy.mil. Reference Navy Case Number 103550.

### BACKGROUND

Distributed sensor networks play an important role for a wide array of applications. These networks are comprised of individual sensor nodes, and are typically powered with a chemical battery. Traditional batteries (i.e. Lithium-ion) are limited in terms of lifetime without being prohibitive in weight. Replacing and recharging such batteries can be both cost prohibitive and dangerous for giving away user locations and improvised explosive device (IED) placement. Therefore mission lifetime of each sensor node is critical and is determined by the amount of energy that can be stored when the system is initially deployed.

### BRIEF DESCRIPTION OF THE DRAWINGS

FIG. 1 shows a schematic view of a system in accordance with the Polymer Electrolyte Fuel Cell-Based (PEM-FC) Power System for Long-Term Operation of Leave-In-Place Sensors.

FIG. 2 shows a power curve for the PEM-FC in accordance with the PEM-FC Power System for Long-Term Operation of Leave-In-Place Sensors.

FIG. 3 shows a power flow diagram between the fuel cell and load in accordance with the PEM-FC Power System for Long-Term Operation of Leave-In-Place Sensors.

FIG. 4 shows examples of sodium borohydride and catalyst packaged in blister packs in accordance with the PEM-FC Power System for Long-Term Operation of Leave-In-Place Sensors.

FIG. 5 shows a flow chart of a method in accordance with the PEM-FC Power System for Long-Term Operation of Leave-In-Place Sensors.

FIG. 6 shows a block diagram of a system in accordance with the PEM-FC Power System for Long-Term Operation of Leave-In-Place Sensors.

### DETAILED DESCRIPTION OF SOME EMBODIMENTS

Described herein is an autonomous power-on-demand fuel cell system currently being developed. The system is designed to extend typical mission lifetime six-fold by replacing non-rechargeable primary batteries with stored hydrogen and a fuel cell. This system utilizes hydrogen gas generated through a reaction between the solid chemical sodium borohydride and water. The chemical delivery mechanism utilizes feedback from the fuel cell output voltage in order to determine the amount of sodium borohydride to be metered into the reaction vessel. The fuel cell can power the load directly or indirectly through a small rechargeable battery. A boost converter can be used to increase voltage output and an integrated power path controller can set whether load power is delivered via the fuel cell or battery. The deployed system will greatly extend the lifetime of existing sensors while reducing risk of harm to the user.

Reference in the specification to “one embodiment” or to “an embodiment” means that a particular element, feature, structure, or characteristic described in connection with the embodiments is included in at least one embodiment. The appearances of the phrases “in one embodiment,” “in some embodiments,” and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

The power delivery system described herein integrates a Polymer Electrolyte Fuel Cell-Based (PEM-FC) Power System, solid chemical energy storage, and an efficient and automated control system capable of providing power to unattended sensors or other payloads for extended periods of time (6-12 months). For this implementation, the PEM-FC is sized according to the power requirements of the remote sensor node, and size, weight, and power (SWaP) can be customized for specific applications. Fuel Cells run on hydrogen and oxygen, so a method for storing and providing hydrogen gas is essential for this system and is described below.

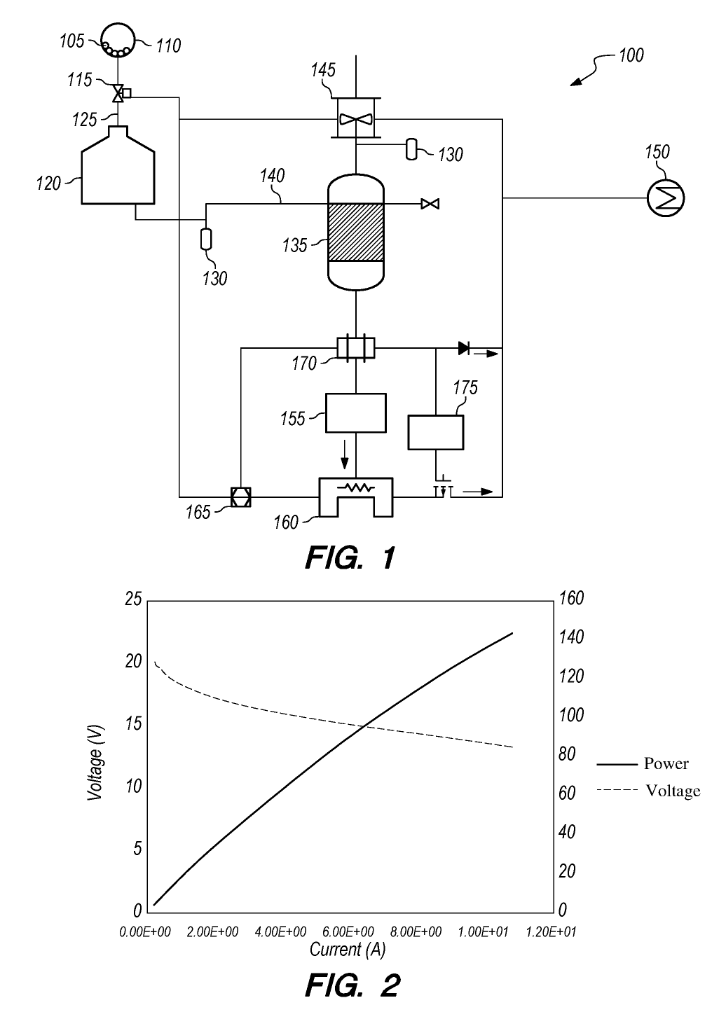

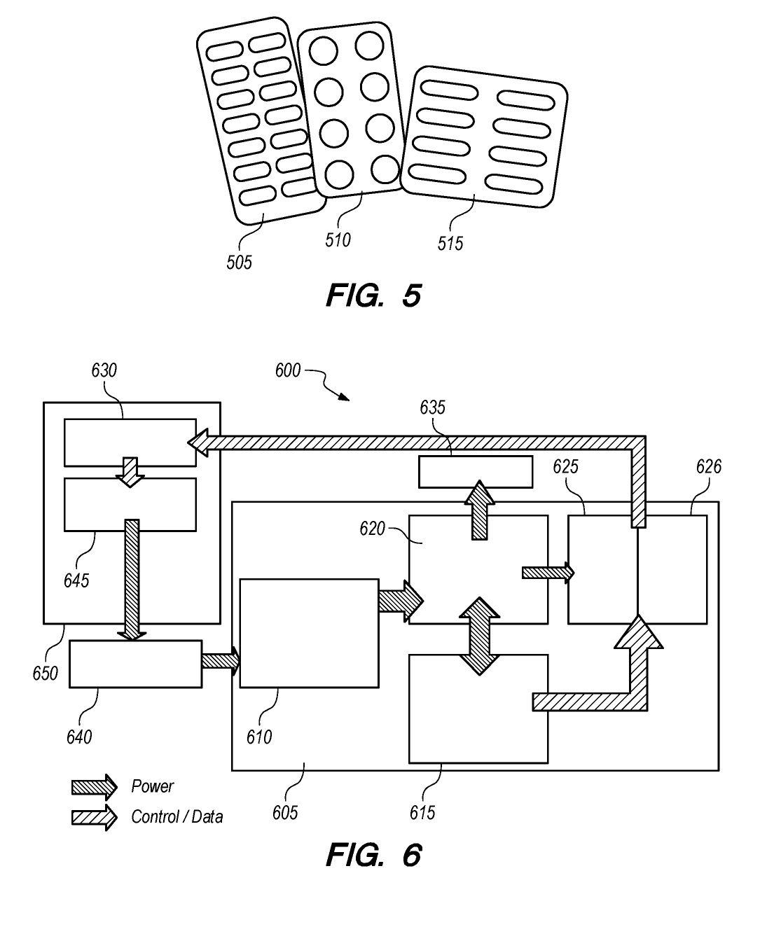

FIG. 1 shows one embodiment of a PEM-FC system 100 wherein sodium borohydride (NaBH₄) 105 is housed in a chemical reservoir 110 attached to a chemical delivery device/valve 115 that leads to a water reservoir 120. Sodium borohydride releases a large amount of hydrogen gas (H₂) (four moles to every mole of NaBH₄) when mixed with water through a hydrolysis reaction. In system 100, water and NaBH₄ are stored rather than gaseous H₂. While the stored energy density of NaBH₄ is lower than that of highly pressurized H₂ gas, it allows for safer transportation, no leakage issues, and easier replacement for extended mission lifetime. Sodium borohydride 105 will be in pellet-form and housed in blister packs, visible in FIG. 5. A catalyst is required to initiate hydrolysis, and the catalyst could be pre-mixed with the water or the sodium borohydride. Alternatively, the catalyst could also be pre-mixed with the sodium borohydride in the blister packs. When needed, the chemical will be pushed out of the pack through the aluminum foil and into the water so the reaction can occur. The catalyst is not visible in FIG. 1. Hydrogen will be formed in reservoir 120 once the catalyst, NaBH₄ 105, and water are mixed. A pipe 125 will lead from the chemical delivery to the water reservoir. In this embodiment, the chemical/catalyst/and water are now all in one big reservoir 120.

A water trap 130 is used to eliminate any excess moisture droplets and humidity from the produced hydrogen stream. The reaction to produce hydrogen is very effervescent. The main component of system 100 is a Polymer Electrolyte Fuel Cell (PEM-FC) 135. Since only the hydrogen gas is needed, the liquid will be eliminated into water traps 130 before the hydrogen gas enters PEM-FC 135. This hydrogen gas is running through pipe 140 to get from reaction reservoir 120 to PEM-FC 135. Pipe 140 is connected to a port on the anode side of PEM-FC 135. On this side of PEM-FC 135, the hydrogen is oxidized to protons (H+). The oxygen (air) exits the other half of PEM-FC 135 (cathode side). A continuous supply of fresh air is provided by a blower 145, which in some embodiments is a fan. Alternatively, a tank of compressed air or oxygen could be connected to the cathode of PEM-FC 135 to provide oxygen. At the cathode side of PEM-FC 135, oxygen is reduced to hydroxide ions (OH—). An ion permeable membrane (not visible here) separates the anode and cathode sides of PEM-FC 135. The ions produced by the oxidation-reduction reaction and able to combine and produce water (H++OH--->H2O). This water then exits PEM-FC 135 as water vapor in either the anode or cathode exhaust.

In order to operate the energy storage and the PEM-FC together an automated control system is utilized to control the interaction between the fuel cell and the energy storage. The control system monitors H₂ gas, PEM-FC voltage and sensor demands automatically utilizing sensors and feedback in order to determine when more hydrogen gas is needed and when to add a corresponding amount of NaBH₄ (and catalyst). This automated control system then mixes the NaBH₄ into a small tank of water via a metering and electro-mechanical mechanism, thereby releasing hydrogen gas to power the PEM-FC. The amount of hydrogen gas needed is based on the demands of the sensor system and the PEM-FC all of which is automatically determined by the control system.

In addition, the reaction using catalyst-doped pellets does not consume the entire amount of catalyst, leaving the catalyst in the solution for future reactions. This evolves gas faster and increases the temperature. Without careful control, this reaction process will become unstable for PEM-FC system 100 and will require modification either to the amount of catalyst, or require moving away from using the catalyst and adding acid to the solution. In addition, the interior of reservoir 120 will likely require a polytetrafluoroethylene (or similar inert) coating to prevent degradation and leaching of reservoir 120.

Continuing with FIG. 1, load 150, battery 155, and charger 160 are all electrically connected to transfer electrical power. An automated electro-mechanical control system, hereinafter called microcontroller 165, is connected to battery 155 and a charge controller 170. Microcontroller 165 also acts as a chemical metering/dosing device controller so it can monitor battery 155 and add more NaBH₄ 105 when needed. Charge controller 170 is used to maintain charging of battery 155. Charge controller 170 is also used to stabilize the voltage from PEM-FC 135.

Battery charger 155 uses a power path controller 175 to determine whether to draw power generated from PEM-FC 135 or to rely on battery 160 backup power, similar to a laptop computer. By holding load 150 in a low-power sleep mode, battery 160 is able to maintain load 150 for an extended period of time, and power from PEM-FC 135 is only required when load 150 is activated or when battery 160 storage capacity is exhausted.

FIG. 2 shows a typical power curve of the fuel cell. The fuel cell is supplied with hydrogen fuel by way of a unique solid chemical energy storage mechanism. This mechanism, described here allows for the storage of hydrogen gas in the form of NaBH₄ which has a far higher energy density than gaseous hydrogen. The extremely high energy density of solid NaBH4 means that the overall system has an extremely high energy density. In addition the use of NaBH4 allows for the simple replacement of fuel when necessary. The NaBH₄ is sealed off from the water storage in order to prevent water ingress/egress. The idea of storing energy in the form of NaBH₄ instead of hydrogen will allow for greater safety, smaller and less expensive equipment, and much longer operation times.

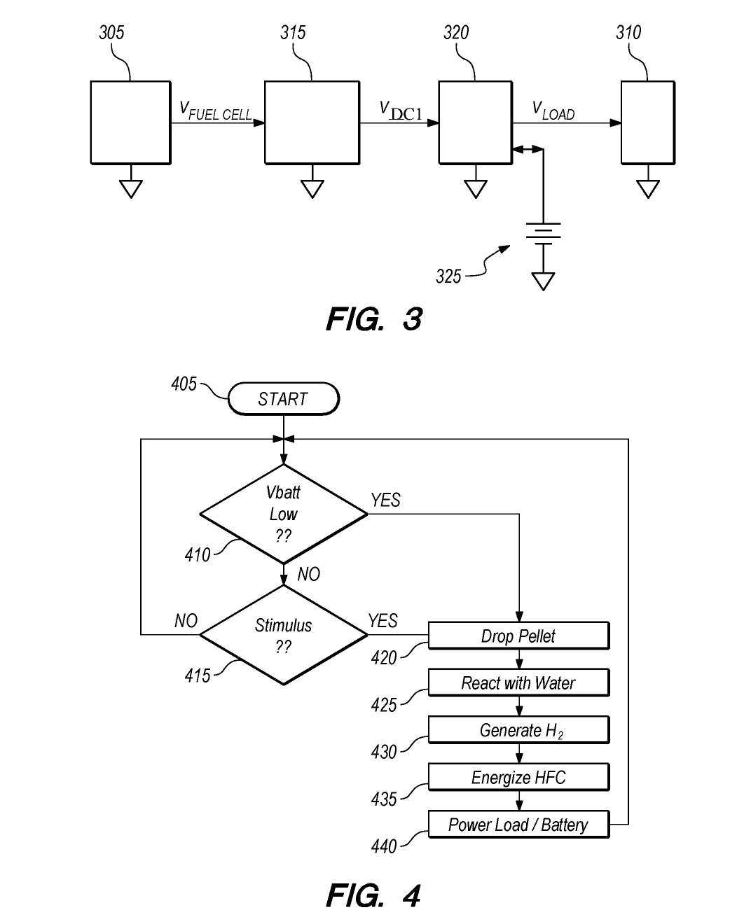

FIG. 3 shows a power flow diagram between a fuel cell 305 and a load 310. Voltage flows from a fuel cell 305 into DC/DC Converter 315. From there, voltage flows into a battery charger 320. Voltage then powers load 310, and excess voltage can be stored in battery 325.

FIG. 4 shows a flow chart of a method 400 of using system 100 described in FIG. 1. Method 400 begins at start 405. If the battery low (step 410) then a message is sent to drop a pellet of hydrogen plus the catalyst into a tank of water (step 420) causing a hydrolysis (step 425). When the pellet and water generate hydrogen gas (H₂) at step 430, the hydrogen gas flows to the hydrogen fuel cell (HFC) at step 435. The HFC can then charge up a load or battery at step 440. Method 400 can also move forward with a stimulus (step 415) causing a hydrogen/catalyst pellet to drop at step 420 instead of a low battery at step 410. An example of a stimulus may be a voltage increase or decrease from a stable baseline generated by a sensor such as a vibration, shock, or motion detector sensor.

FIG. 5 shows blister packs 505 and 510 containing NaBH₄ in the form of pellets. Blister pack 515 has a pellet of NaBH₄ combined with a catalyst.

FIG. 6 shows a block diagram of a system 600 in accordance with the PEM-FC Power System for Long-Term Operation of Leave-In-Place Sensors. System 600 comprises a printed circuit board (PCB) 605 having a boost converter 610, a battery 615, a battery charger and power path 620, a stepper driver 625 and battery balancer 626. Stepper driver 625 converts the battery 615 voltage into a regulated voltage and current that is usable by a stepper motor a 630. Stepper driver 625 also enables stepper motor 630 to count the number of steps and provide some circuit protection like over-current, over-temperature, and current limitation. Battery balancer 626 is a circuit that is going to balance a system load 635 and the charge from a hydrogen fuel cell (HFC) 640 being applied to battery 615 composed of multiple cells. Battery balancer 626 ensures that all the cells in battery 615 are being used and charged in roughly the same manner. This extends the life time and efficiency of the entire system 600.

Stepper motor 630 and a pellet dropper 645 are both found inside a pressure vessel 650. Pressure vessel 650 can be used to combine sodium borohydride, a catalyst, and water, resulting in hydrolysis. Stepper motor 630 is a type of precision motor that rotates an axle. This axle is divided up into a finite number of steps. A microcontroller (not visible in this figure) sends a command to turn the motor some number of steps, causing pellet dropper 645 to release a pellet of sodium borohydride (not visible in this figure.) System 600 utilizes boost converter 610 that can be used to increase the voltage output from HFC 640.

The system described herein includes the integration of these three subsystems (PEM-FC, energy storage and control system) which are fully integrated to complete the working system and provide power to existing sensor equipment all while operating unattended.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for power delivery comprising the steps of:
coupling a polymer electrolyte membrane fuel cell (PEM-FC) to a load system, wherein the PEM-FC is powered by hydrogen gas and oxygen;
using a blower to deliver oxygen to the PEM-FC;
using an automated electro-chemical control system operably coupled with the PEM-FC to monitor PEM-FC hydrogen gas levels, PEM-FC voltage, and load demands;
determining that more hydrogen gas is required to fuel the PEM-FC, said step being determined via the control system;
mixing sodium borohydride, a catalyst, and water, releasing hydrogen gas and delivering the hydrogen gas to the PEM-FC, said step resulting in powering the PEM-FC;
transferring the resulting power from the PEM-FC to the load system.

2. The method of claim 1 further comprising the step of storing the water and catalyst in a reservoir proximate to the PEM-FC and storing the sodium borohydride in pellet form in a vessel sealed off from the reservoir.

3. The method of claim 2, further comprising the step of coupling a battery and a battery charger to the PEM-FC.

4. The method of claim 3 wherein the automatic electro-chemical control system detects when the battery is low, triggering the release of more hydrogen gas.

5. The method of claim 4 wherein the sodium borohydride and water are mixed with an acidic catalyst.

6. The method of claim 5 further comprising the step of using a blower to supply oxygen to the PEM-FC, wherein the blower is operably coupled to the PEM-FC.

7. The method of claim 1 wherein a boost converter is used to increase the voltage output.

8. The method of claim 1 wherein an integrated power path controller sets whether load power is delivered via the PEM-FC or the battery.

9. A system comprising:
a chemical reservoir in fluidic connection to a water reservoir,
wherein the water reservoir is in fluidic connection to a fuel cell;
wherein the fuel cell is powered by hydrogen and oxygen and has an anode and a cathode separated by an ion permeable membrane;
the fuel cell being electrically coupled to a load, a battery, and a battery charger; and
a microcontroller electrically connected to the battery, a charge controller, and a chemical metering device, wherein the microcontroller is configured to acts as a chemical metering and dosing device.

10. The system of claim 9 wherein the chemical reservoir further comprises sodium borohydride pellets contained therein and the water reservoir further comprises water contained therein.

11. The system of claim 10, wherein a catalyst is pre-mixed with the water contained within the water reservoir.

12. The system of claim 10, wherein a catalyst is contained within the sodium borohydride pellet.

13. The system of claim 12 wherein a water trap is disposed between the water reservoir and the fuel cell.

14. The system of claim 13, wherein a blower is operatively coupled to the fuel cell.

15. The system of claim 13, wherein a tank of compressed oxygen is operatively coupled to the fuel cell.

16. The system of claim 15 further comprising a boost converter used to increase the voltage output from the fuel cell.

17. The system of claim 16 wherein the catalyst and sodium borohydride are contained in blister packs.

18. A method comprising the steps of:
using a fuel cell to power an electric device, wherein the fuel cell runs on hydrogen and oxygen and the fuel cell is electrically coupled to the electric device;
providing the fuel cell with hydrogen obtained from sodium borohydride, wherein the sodium borohydride is added to a catalyst and water allowing hydrolysis to occur;
delivering the hydrogen to the fuel cell via tubing that connects the fuel cell to a reservoir containing the water, sodium borohydride, and catalyst; and
using a blower to deliver oxygen to the fuel cell.

19. The method of claim 18 further comprising the step of electrically coupling a battery and a battery charger to the fuel cell, wherein the fuel cell can also power the battery.

20. The method of claim 19, further comprising the step of using a chemical dosing device coupled to the battery to detect when battery power is low and signal more sodium borohydride to be added to the catalyst and water.
